(19) United States
(12) Patent Application Publication
(10) Pub. No.: US 2026/0161478 A1
(43) Pub. Date: Jun. 11, 2026

(54) AUTOMATIC RESOURCE ALLOCATION AND SCHEDULING IN ARTIFICIAL INTELLIGENCE INFERENCE SYSTEMS

(71) Applicant: MangoBoost, Inc., Bellevue, WA (US)

(72) Inventors: Duncan Jan Maxwell MOSS, Portland, OR (US); Daniar Heri KURNIAWAN, Bellevue, WA (US); Edwin Guhnyoung LIM, Seattle, WA (US); Heetaek JEONG, Bellevue, WA (US); Eriko NURVITADHI, Bellevue, WA (US)

(21) Appl. No.: 19/345,994

(22) Filed: Sep. 30, 2025

Related U.S. Application Data
(60) Provisional application No. 63/728,614, filed on Dec. 5, 2024.

(51) Int. Cl. G06F 9/50

(52) U.S. Cl. CPC G06F 9/5055; G06F 2209/503

(57) ABSTRACT

Technologies for automatic resource allocation in an AI inference system are disclosed. An example method includes obtaining a target AI model to be deployed, comparing the target AI model to a plurality of reference AI models previously deployed via the AI inference system, and responsive to a result of the comparing: obtaining a base allocation configuration of resources for deploying the target AI model via the AI inference system; and performing a configuration search based on the base allocation configuration to obtain a finalized allocation configuration.

### BACKGROUND

### Technical Field

The present disclosure generally relates to optimization in artificial intelligence (AI) inference systems, and more particularly, to automatic resource allocation and request scheduling for AI inference.

### Description of the Related Art

A variety of AI methods have been proposed, including those based on artificial neural network. Typically, a neural network (NN) formulates neurons and synapses in human brains as a model (NN-model) in a computational manner. Illustratively, a computer teaches an NN-model by using many known inputs with known answers. Such a learning phase is typically known as training. After an NN-model is trained, it can be deployed to predict answers for new inputs. Such deployment is typically referred to as inference. An NN-model typically includes multiple connected layers, where each layer can be some form of tensor operations (e.g., vector or matrix operations). An NN-model is therefore often described with its structure (e.g., number and type of tensor layers, how they connect, etc.) and weights (e.g., tensor values in each layer).

### BRIEF SUMMARY

In some embodiments, a computer-implemented method comprises: obtaining a target artificial intelligence (AI) model to be deployed via an AI inference system; comparing the target AI model to a plurality of reference AI models previously deployed via the AI inference system; responsive to a result of the comparing: obtaining a base allocation configuration of resources including at least memory and compute resources, for deploying the target AI model via the AI inference system; and performing a configuration search based on the base allocation configuration to obtain a finalized allocation configuration; and allocating resources of the AI inference system to implement the target AI model based on the finalized allocation configuration.

In some embodiments, comparing the target AI model to the plurality of reference AI models comprises one or more of: calculating one or more layout similarities between the target AI model and the plurality of reference AI models; calculating one or more dimensional similarities between the target AI model and the plurality of reference AI models; or calculating one or more operation similarities between the target AI model and the plurality of reference AI models. In some embodiments, comparing the target AI model to the plurality of reference AI models includes: calculating one or more combined similarities based on the one or more layout similarities, the one or more dimensional similarities, and the one or more operation similarities.

In some embodiments, comparing the target AI model to the plurality of reference AI models is based on a similarity threshold. In some embodiments, the result of the comparing indicates successful identification of a base AI model from the plurality of reference AI models that is within the similarity threshold to the target AI model, and wherein the base allocation configuration is associated with the base AI model.

In some embodiments, the result of the comparing indicates that no reference AI model is found to match the target AI model, and wherein obtaining the base allocation configuration comprises determining one or more of a pipeline parallelism, tensor parallelism, or data parallelism for the target AI model. In some embodiments, the method comprises: calculating a cache size to implement the target AI model based on a memory usage of a request; calculating a minimum number of compute units to implement the target AI model based on a size of the target AI model, the cache size, and a memory capacity of a compute unit; determining the pipeline parallelism for the target AI model based on the minimum number of compute units and a number of compute units per node; determining the tensor parallelism for the target AI model based on the minimum number of compute units and the pipeline parallelism; determining the data parallelism for the target AI model based on a number of compute units, the tensor parallelism, and the pipeline parallelism; and determining the base allocation configuration based on one or more of the tensor parallelism, the pipeline parallelism, or the data parallelism. In some embodiments, the method comprises: obtaining a latency target for the target AI model; calculating an execution time per compute unit for the target AI model; and modifying the tensor parallelism based on the execution time per compute unit.

In some embodiments, the method comprises: tracking a performance metric of one or more of the plurality of reference AI models implemented via the AI inference system; and determining the base allocation configuration based on the performance metric.

In some embodiments, performing the configuration search comprises: iteratively altering the base allocation configuration; for each iteration of the altering, determining performance of a respective base allocation configuration of the iteration by implementing the target AI model according to the altering of the base allocation configuration of the iteration; determining that a difference between the performance of a respective base allocation configuration of a first iteration and the performance of a respective base allocation configuration a second iteration is smaller than a performance similarity threshold; and determining the finalized allocation configuration based on determining that the difference is smaller than the performance similarity threshold.

In some embodiments, a system comprises one or more processors, and one or more non-transitory computer-readable media collectively storing instructions that, when collectively executed by the one or more processors, cause the system to perform actions. The actions comprise: comparing a target AI model to a plurality of reference AI models previously implemented via an AI inference system; responsive to a result of the comparing: obtaining a base allocation configuration of resources for implementing the target AI model via the AI inference system; and performing a configuration search based on the base allocation configuration to obtain a finalized allocation configuration; and causing allocation of resources of the AI inference system to implement the target AI model based on the finalized allocation configuration.

In some embodiments, comparing the target AI model to the plurality of reference AI models comprises one or more of: calculating one or more layout similarities between the target AI model and the plurality of reference AI models; calculating one or more dimensional similarities between the target AI model and the plurality of reference AI models; or calculating one or more operation similarities between the target AI model and the plurality of reference AI models.

In some embodiments, comparing the target AI model to the plurality of reference AI models is based on a similarity threshold. In some embodiments, the result of the comparing indicates successful identification of a base AI model from the plurality of reference AI models that is within the similarity threshold to the target AI model, and wherein the base allocation configuration is associated with the base AI model.

In some embodiments, the result of the comparing indicates that no reference AI model is found to match the target AI model, and wherein obtaining the base allocation configuration comprises determining one or more of a pipeline parallelism, tensor parallelism, or data parallelism for the target AI model.

In some embodiments, the system includes the AI inference system.

In some embodiments, a non-transitory processor-readable storage medium storing computer instructions that, when executed by one or more processors, cause actions to be performed. The actions comprise: comparing a target AI model to a plurality of reference AI models previously implemented via an AI inference system; responsive to a result of the comparing: obtaining a base allocation configuration of resources for implementing the target AI model via the AI inference system; and performing a configuration search based on the base allocation configuration to obtain a finalized allocation configuration; and causing allocation of resources of the AI inference system to implement the target AI model based on the finalized allocation configuration.

In some embodiments, the actions comprise: obtaining a latency target for the target AI model; calculating an execution time per compute unit for the target AI model; and modifying a tensor parallelism for the target AI model based on the execution time per compute unit.

In some embodiments, the actions comprise: tracking a performance metric of one or more of the plurality of reference AI models implemented via the AI inference system; and determining the base allocation configuration based on the performance metric.

In some embodiments, performing the configuration search comprises: iteratively altering the base allocation configuration; for each iteration of the altering, determining performance of a respective base allocation configuration of the iteration by implementing the target AI model according to the altering of the base allocation configuration of the iteration; determining that a difference between the performance of a respective base allocation configuration of a first iteration and the performance of a respective base allocation configuration a second iteration is smaller than a performance similarity threshold; and determining the finalized allocation configuration based on determining that the difference is smaller than the performance similarity threshold.

In some embodiments, a computer-implemented method comprises: obtaining an input request to an artificial intelligence (AI) inference system, wherein the AI inference system is configured to implement a set of neural network models via a plurality of AI compute devices; predicting usage of resources including compute and memory resources for the AI inference system to process the input request using at least one neural network model that is implemented via at least one AI compute device; monitoring the AI inference system to determine available resources of the AI inference system; and scheduling the input request to target resources of the AI inference system based on the predicted usage of resources and the available resources of the AI inference system.

In some embodiments, scheduling the input request to target resources of the AI inference system comprises matching the predicted usage of resources to the available resources of the AI inference system at a given time.

In some embodiments, predicting the usage of resources is based on historical input request processing data including one or more of user-specific data, temporal data, or contextual data of input requests processed by the AI inference system prior to the obtaining of the input request.

In some embodiments, predicting the usage of resources comprises selecting at least one prediction method for the predicting based on one or more of system workload, user characteristics, or request complexity.

In some embodiments, predicting the usage of resources is based on a similarity search that compares the input request to one or more reference requests.

In some embodiments, scheduling the input request to target resources of the AI inference system comprises grouping the input request with at least another input request to balance resource usage across the plurality of AI compute devices.

In some embodiments, the input request to target resources of the AI inference system comprises routing the input request to a target neural network model with a higher resource availability than another neural network model as deployed via the AI inference system.

In some embodiments, a system comprises one or more processors, and one or more non-transitory computer-readable media collectively storing instructions that, when collectively executed by the one or more processors, cause the system to perform actions. The actions comprise: obtaining an input request to an artificial intelligence (AI) inference system, wherein the AI inference system is configured to implement a set of neural network models via a plurality of AI compute devices; estimating usage of resources for the AI inference system to process the input request using at least one neural network model that is implemented via at least one AI compute device; determining available resources of the AI inference system; and scheduling the input request to target resources of the AI inference system based on the estimated usage of resources and the available resources of the AI inference system.

In some embodiments, determining the available resources is based on monitoring of resource usage of the AI inference system.

In some embodiments, estimating the usage of resources is based on historical data of input request processing by the AI inference system.

In some embodiments, estimating the usage of resources comprises selecting at least one prediction method for the predicting based on one or more of system workload, user characteristics, or request complexity.

In some embodiments, estimating the usage of resources is based on a similarity search that compares the input request to one or more reference requests.

In some embodiments, scheduling the input request to target resources of the AI inference system comprises grouping the input request with at least another input request based on the estimated usage of resources.

In some embodiments, the system is part of the AI inference system.

In some embodiments, a non-transitory processor-readable storage medium storing computer instructions that, when executed by one or more processors, cause actions to be performed. The actions comprise: obtaining an input request to an artificial intelligence (AI) inference system, wherein the AI inference system is configured to implement a set of neural network models via a plurality of AI compute devices; estimating usage of resources for the AI inference system to process the input request; determining available resources of the AI inference system; and scheduling the input request to target resources of the AI inference system based on the estimated usage of resources and the available resources of the AI inference system.

In some embodiments, scheduling the input request to target resources of the AI inference system comprises matching the estimated usage of resources to the available resources of the AI inference system.

In some embodiments, estimating the usage of resources is based on historical input request processing by the AI inference system prior to the obtaining of the input request.

In some embodiments, estimating the usage of resources comprises selecting at least one prediction method for the predicting.

In some embodiments, estimating the usage of resources is based on comparing the input request with one or more reference requests.

In some embodiments, scheduling the input request to target resources of the AI inference system comprises grouping the input request with at least another input request to balance resource usage of the AI inference system.

### BRIEF DESCRIPTION OF THE SEVERAL VIEWS OF THE DRAWINGS

Like-numbered elements may refer to common components in the different figures.

FIG. 1A shows an example of resource allocation in an AI inference system.

FIG. 1B shows example types of parallelism in resource allocation.

FIG. 1C shows an example of request scheduling in an AI inference system.

FIGS. 2A-2C show an example AI inference system implementing automatic resource allocation and intelligent request scheduling in accordance with some embodiments of the present disclosure.

FIG. 3 shows an example of high-level code for implementing a mathematical configuration model for determining parallelism in accordance with some embodiments of the present disclosure.

FIG. 4 shows an example of high-level code for implementing a mathematical configuration multi-model for determining parallelism in accordance with some embodiments of the present disclosure.

FIGS. 5A and 5B show an example of history- and similarity-based approach for resource allocation in accordance with some embodiments of the present disclosure.

FIG. 6 shows an example of high-level code for configuration search based on iterative grid search in accordance with some embodiments of the present disclosure.

FIG. 7 shows a flow diagram of an example combined approach for resource allocation in accordance with some embodiments of the present disclosure.

FIG. 8 shows an example implementation of dynamic resource-aware scheduling in accordance with some embodiments of the present disclosure.

FIG. 9 shows an example implementation of dynamic resource usage predictor in accordance with some embodiments of the present disclosure.

FIG. 10 shows an example implementation of load-aware tiered resource usage prediction in accordance with some embodiments of the present disclosure.

FIG. 11 shows an example implementation of resource predictor-based request scheduling in accordance with some embodiments of the present disclosure.

FIG. 12 shows an example implementation of resource monitoring-based scheduling in accordance with embodiments of the present disclosure.

FIG. 13 is a block diagram illustrating a computing system or device used to implement some or all the functionalities of the technology disclosed herein.

### DETAILED DESCRIPTION

The evolution of neural networks has progressed significantly, beginning with foundational architectures like multi-layer perceptrons (MLPs) and convolutional neural networks (CNNs), and arriving at Transformers and Generative AI in general. Transformers enabled neural networks to expand into the domain of human language, leading to the development of Large Language Models (LLMs). However, the output generation characteristic of transformers introduces a new challenge. Unlike traditional models with fixed outputs, transformers produce outputs of varying sizes depending on the input. The example below shows the varying size of outputs in chatbot application.
Q: “What is the capital of France?”, A: “Paris”
Output is 1 word.
Q: “Why is Paris considered a cultural hub?” A: “Paris is considered a cultural hub because of its art, architecture, and historic landmarks like the Louvre and Eiffel Tower.”
Output is 20 words.

The variability of output introduces fluctuations in resource requirements (e.g., compute requirements, memory requirements, or the like), creating challenges for efficient scheduling and resource allocation management in large-scale deployments.

An AI Inference system (Inf-Sys) typically includes many AI compute devices (AI-Cs), such as GPUs, TPUs, AI accelerators, etc. The Inf-Sys can accept one or more neural networks models (NN-Ms) that have been trained previously for execution on one or more of the AI-Cs in the system. During runtime, the Inf-Sys can accept input requests (I-Reqs) as inputs, provide these I-Reqs into appropriate NN-M(s) to be computed on AI-C(s), resulting in output responses (O-Resps). As an example, in an AI Inf-Sys for ChatBot usage, it can accept an I-Req such as “what is the capital of USA” and output a corresponding O-Resp of “Washington DC.”

### Resource Allocation in AI Inference System

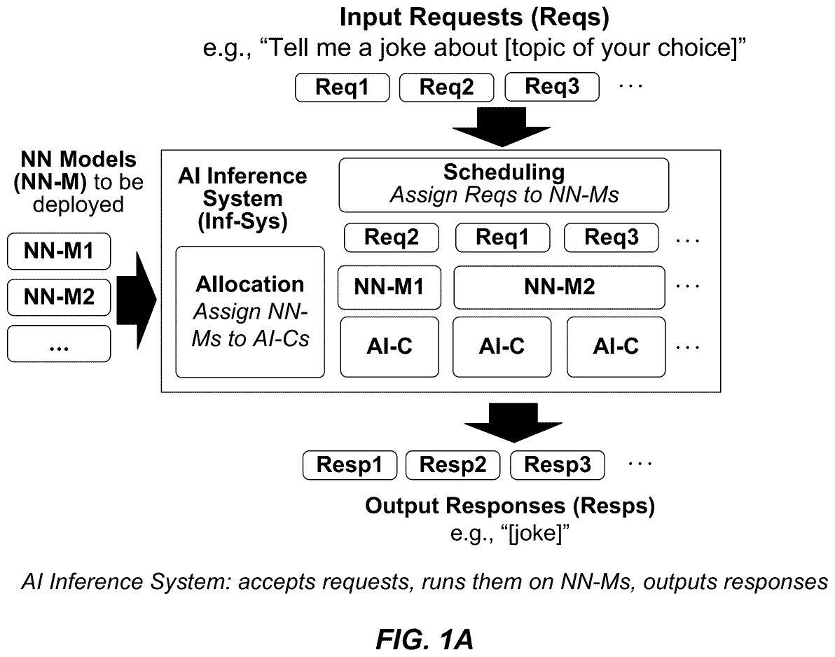

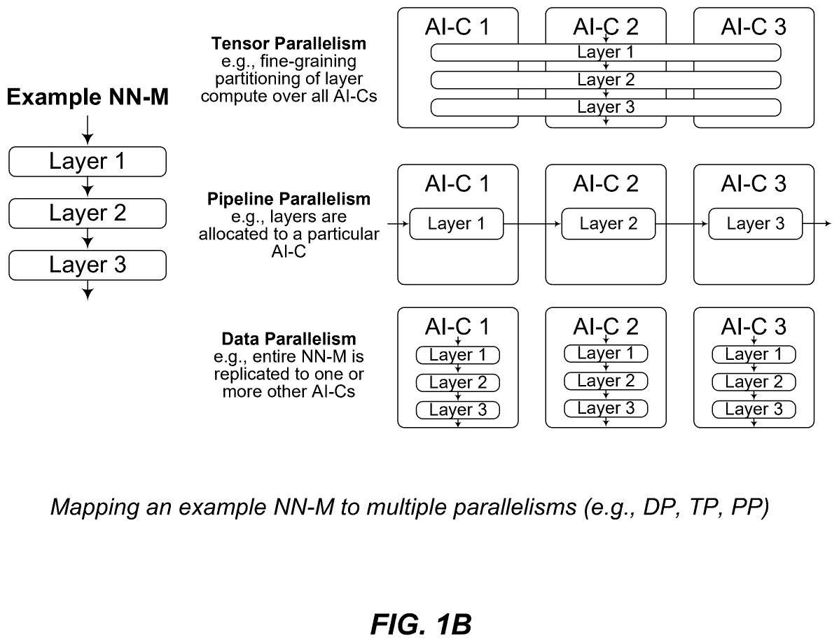

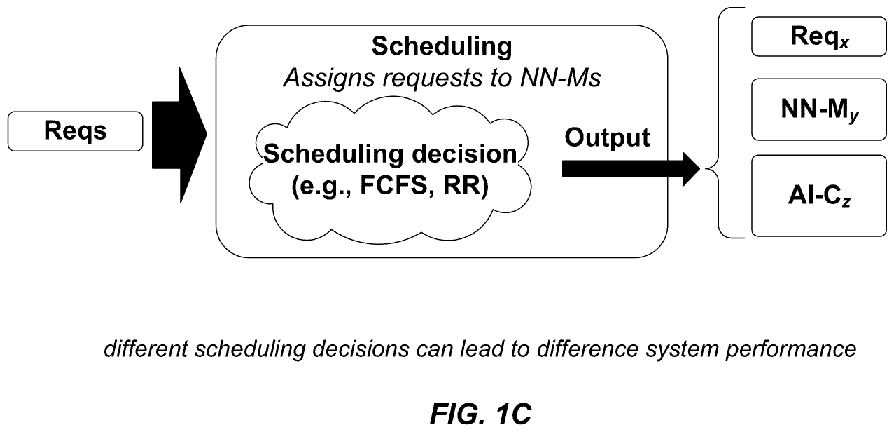

Resource allocation in an Inf-Sys typically includes the process of assigning AI-Cs to particular NN-Ms, as illustrated in FIG. 1A. Multiple factors can affect allocation, such as different types of parallelisms and configurations. FIG. 1B provides an example of some types of parallelism: Tensor Parallelism (TP), Data Parallelism (DP) and Pipeline Parallelism (PP). In the figure, an example of neural network (NN) with three layers are mapped into different levels of parallelism. In TP, each layer (which is a tensor) is divided up across AI-Cs to run in parallel. In PP, each AI-C is assigned its own layer, which executes in parallel. In DP, the entire NN is assigned into a respective AI-C, so multiple instances of the same NN are executed in parallel in multiple AI-Cs.

The goals of parallelism consideration include (1) NN-M(s) have large compute and memory requirements, and need to be partitioned across multiple AI-Cs (e.g., AI-C's arithmetic units and memories) in order to store their underlying data and (2) to improve performance by using the additional compute resources of each AI-C. PP and TP typically aim to address both (1) and (2), whereas DP is typically used for (2).

Typically, TP is designed to be used intra-node (e.g., where all AI-Cs are located in the same machine with a high bandwidth interconnect, such as NVLink) and involves fine-grained partitioning of each NN-M layer over AI-Cs as show in FIG. 1B; PP is designed to be used inter-node, where the bandwidth requirements are significantly lower compared TP, involving partitioning entire layers into separate AI-Cs to keep the communication overhead limited to just layer boundaries; DP replicates the entire NN-M onto multiple individual AI-Cs, where each AI-C operates a copy of the NN-M independently from one another regardless of considerations for scheduling I-Reqs between different AI-Cs. These levels of parallelism are not mutually exclusive, and combinations of two or three are valid; therefore, different configurations that utilize the same number of AI-Cs can have vastly different performances.

The inventor recognizes various disadvantages of existing approaches for resource allocation in Inf-Sys, as summarized in Table 1. First, commercial solutions, such as Triton Inference Server and TorchServe, require user to manually determine the configuration parameters, such as DP, PP, TP, to allocate AI-Cs to NN-Ms. This puts the burden on the users to tune and find optimal allocation to attain best system performance. If a user mistakenly allocates resources in an inappropriate way, AI-Cs can be underutilized, which can result in low Inf-Sys efficiency and performance. These solutions are also not user friendly, as they require users to have deep expertise of the system, including various level of parallelisms and other system configurations (e.g., block size, etc.), to fully understand which requires software, system, and hardware expertise. There is an academic attempt to automate the method to determine system configuration, which is based on binary search of simulated Inf-Sys models. The shortcomings of this attempt include the need to have a Inf-Sys simulation model, which is not as accurate as compared with running the actual Inf-Sys.

### Request Scheduling in AI Inference System

Request scheduling in Inf-Sys involves assigning input requests (Reqs) to NN-M(s) and AI-C(s) for execution, which produce output responses, as illustrated in FIG. 1C. Scheduling decision can impact system performance and efficiency significantly. As an example, if a new Req comes in, and is scheduled to an NN-M/AI-C that is already heavily working to processing existing Reqs, then this new Req can suffer from longer runtime. As another example, if there is an NN-M/AI-C that is idle or under-utilized, but scheduling decision mistakenly does not assign new Req onto it, it can stay idle and reduce system utilization and overall system throughput.

An improved scheduler design aims to keep track of or otherwise obtain information on how much system resources (e.g., AI-C's compute and memory resources) that any given input Req(s) requires, and schedule the Req(s) to NN-M/AI-C(s) in a way to efficiently utilize available system resources, to result in desirable system performance.

The inventor recognizes various disadvantages of existing approaches for request scheduling in Inf-Sys, as summarized in Table 1. Current Inference Servers, such as Triton and TorchServe, implement a first-come-first-serve (FCFS) approach to the request queue, or some other variant of fixed heuristics. When dealing with multiple instances of the same model typically a round-robin (RR) approach is used. Such FCFS-RR might handle neural networks that have deterministic behavior, with an even compute and memory resource distribution. However, modern neural networks, such as Transformers and LLMs, exhibit non-determinism where compute and memory resource utilization can vary dynamically. Hence the FCFS-RR method may result in system inefficiencies, where a given set of input requests may mistakenly get assigned onto NN-M/AI-C that does not have sufficient resources, leading to performance slowdowns.

There are academic attempts to develop request schedulers, but they do not take into account system resource utilization when routing requests to multiple model deployments. This can lead to low performance when request is routed to a deployment with low resource availability. In the context of LLM inference, predicting the resource usage of incoming requests is also important to efficiently utilize system resources. Prior work has some narrowly-focused exploration of predicting memory usage of incoming requests, but does not take into account other factors, such as compute intensity and historical user activities.

None of these scheduling systems use historical information, such as task complexity, or consider the user profile from the previous requests. Available system resources are often tracked by telemetry, however these are not evaluated when make decisions about which NN-M/AI-C to schedule a particular request (Req). Finally, analysis by mathematical model or prediction of the request complexity have not been taken into account at time of scheduling. For example, metrics such as the amount of compute and memory required to service the request can ensure that the selected AI-C has the capacity to handle the request.

TABLE 1
Brief Summary of Existing Allocation and Scheduling Approaches

| | Resource | |
|---|---|---|
| Existing | Allocation | |
| Technology | Method | Scheduling Algorithm |
| Triton Inference | Manual | FCFS-RR |
| Server | | |
| TorchServe | Manual | FCFS-RR |
| Vidur | Simulation + | N/A |
| | Search | |
| SSJF | N/A | Scheduling based on |
| | | predicting output token |
| | | length. Does not use |
| | | monitored system resources. |
| S3 | N/A | Scheduling based on |
| | | memory usage prediction. |
| | | Does not use dynamic |
| | | resource monitoring. |

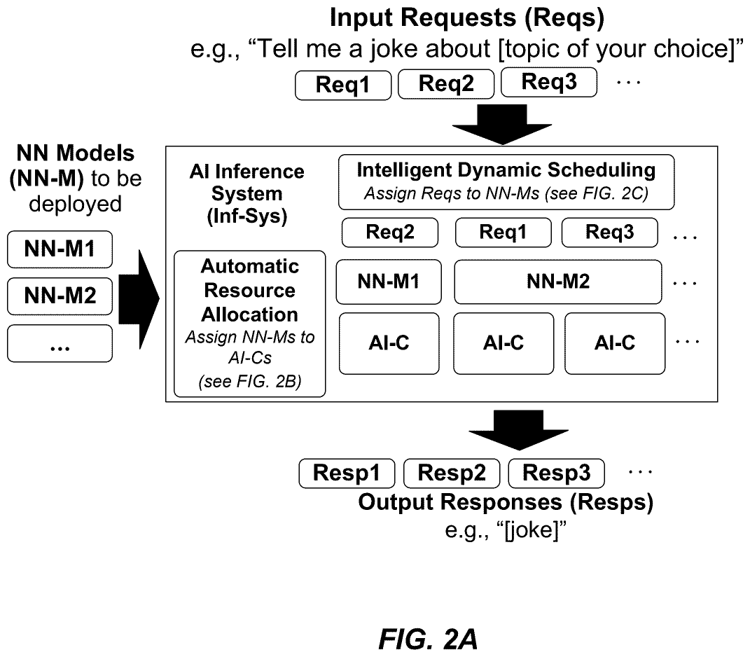

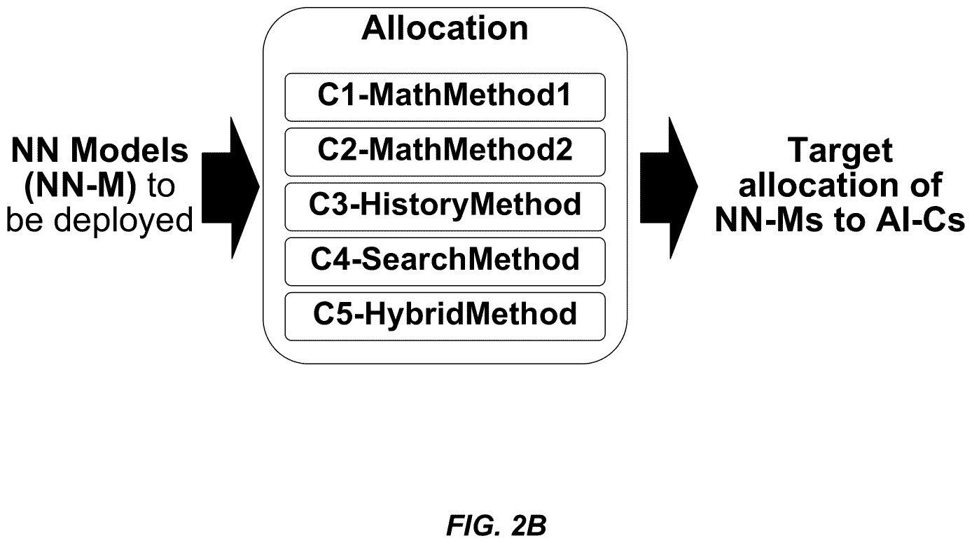

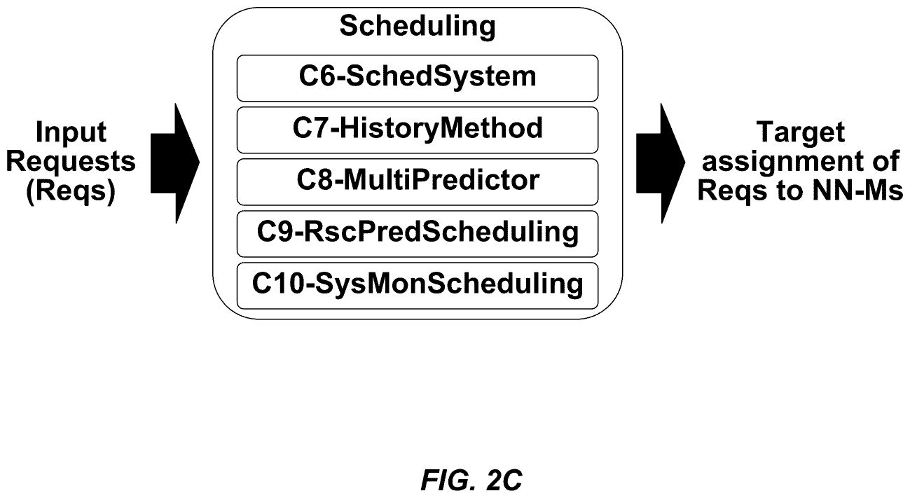

To address at least the issues discussed above, the inventor has conceived and reduced to practice embodiments of the presently disclosed technology. FIG. 2A shows an example of an AI inference system in accordance with some embodiments, which incorporate example methods and sub-systems for automatic resource allocation and intelligent request scheduling that are summarized in FIGS. 2B and 2C, respectively. By more efficiently allocating resources and scheduling requests, embodiments of the presently disclosed technology improve system utilization and overall performance. The presently disclosed technology further improves user-friendliness, as the automated approaches allow users to use the system without needing manual resource allocation, which requires deep system expertise. Hence, high-level users, such as data scientists, can easily use the system and enjoy a high-level of AI inference performance. In accordance with various embodiments, the presently disclosed technology implements automatic resource allocation using one or more of the following techniques:

Technique 1—automatically allocating AI inference system resources to an AI model, using a mathematical configuration model approach.

Allocating AI-Cs to a given model (NN-M) is typically done via a user provided configuration. There is often a straightforward and naïve approach to determining the different deployment parameters, however maximizing performance of the AI-Cs is a non-trivial problem and requires deep knowledge of the underlying system and its configuration such as memory hierarchy and compute throughput. On top of this, determining deployment parameters that are specific to particular NN-M, such as the levels of parallelism (TP, DP and PP), block_size, kvcache_gpu_utilization, etc., requires domain expertise in deep learning and is impractical to be performed by just any system engineer. Since data scientists who develop and deploy NN-M are unlikely to know or understand the details of the underlying AI-Cs, deployments on these systems often lead to suboptimal performance.

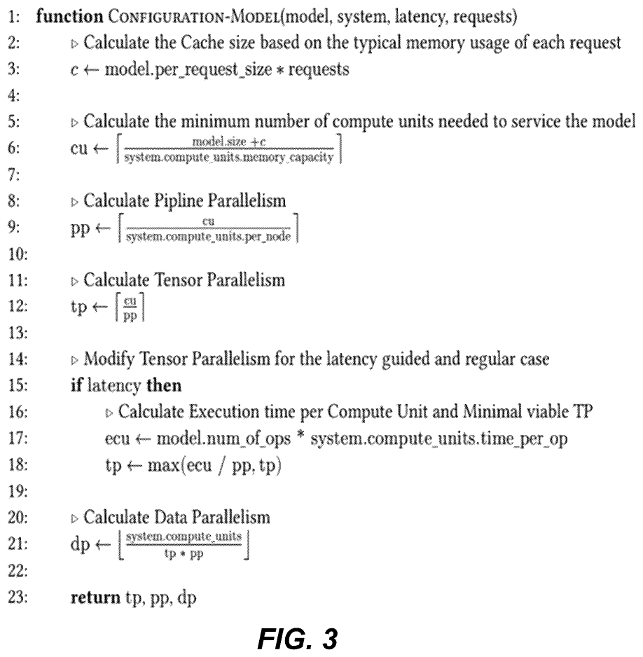

FIG. 3 shows an example of high-level code for implementing a mathematical configuration model aiming to determine optimal parallelism. The implementation automatically computes near-optimal deployment parameters for the levels of parallelism based on the memory requirements of the NN-M and design of the Inf-Sys (e.g., multiple nodes in a data center, multiple GPUs per node). As illustrated in FIG. 3, given a NN-M, a Inf-Sys and optionally latency and I-Req requirements, the minimum number of AI-Cs needed to store the NN-M is computed based on the memory footprint of the NN-M and the expected cache size needed to sustain I-Reqs. Then PP and TP are calculated based on the Inf-Sys's intra- and inter-node connectivity. Finally, DP is allocated based on the remaining resources after PP and TP allocation.

In some embodiments, this implementation can include maximizing the throughput for N parallel requests (e.g., where N is configurable and determined at setup time), however the user can provide hints such as a desired latency target as well as the target number of parallel requests. For example, if the user intends to run Llama3.1-70B on a server with 8xMI300x GPUs with no latency target and the default number of parallel requests, the implementation flow can be as follows:

The cache size is determined to be roughly 40 GB based on the size of each request and the number of parallel requests. (See FIG. 3, line 3).

The minimum number of compute units is determined to be 1, since model size (140 GB)+cache size (40 GB)=180 GB, which divided by the memory capacity of each MI300x (192 GB) is less than 1. (See FIG. 3, line 6.)

Since there are 8 GPUs per node, PP will also be 1 (⅛). (See FIG. 3, line 9.)

TP will be 1, since the minimum number of compute units divided by PP will be 1/1. (See FIG. 3, line 12.)

Finally for DP, the total number of compute units is divide by PP*TP, which will be 8 (8/1*1=8). (See FIG. 3, line 21.)

Technique 2—automatically allocating AI inference system resources to multiple AI models, using a mathematical configuration multi-model approach.

In Inf-Sys, it is uncommon that a complete application relies only on a single NN-M. Mostly these are complex systems that include a combination of several NN-Ms, all of which need to be serviced in parallel. Determining the resource allocation of these NN-Ms is a challenging problem, especially when different I-Req throughputs need to be balanced.

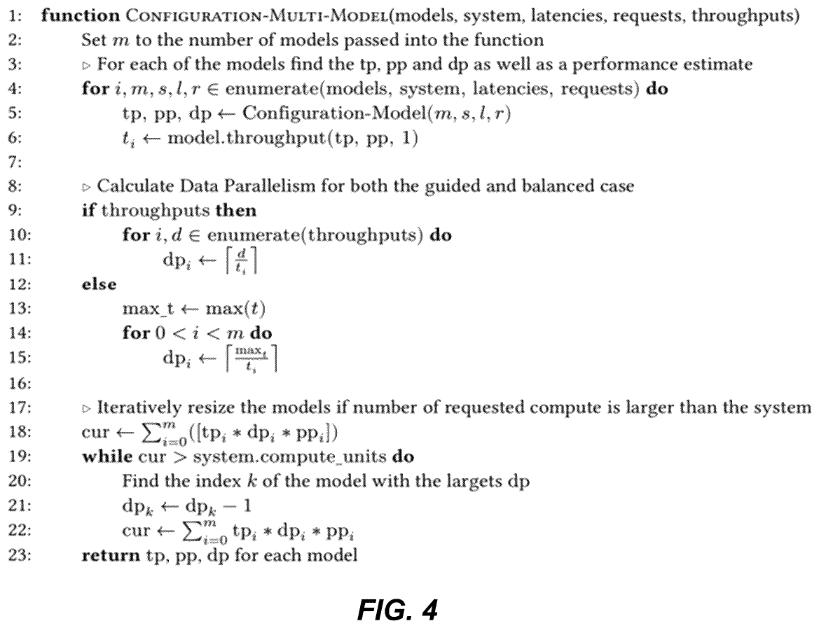

FIG. 4 shows an example of high-level code for implementing a mathematical configuration multi-model aiming to determine optimal parallelism in multi-model deployments. This technique is an extension on Technique 1 by handling multi-NN-M deployment scenarios. Illustratively, first the TP and PP for each model is calculated using Technique 1. Next the DP for each model is allocated based on throughput matching or guided by an optional user input. Finally, the DP allocation is resized based on the availability of resources in the Inf-Sys.

Technique 3—automatically allocating AI inference system resources to AI model(s), based on historical knowledge of prior runs.

In accordance with some embodiments, this technique includes (a) tracking the history of previously-run NN-M(s) on the inference system, its allocations, and resulting system performance; and (b) using such historical insights to automatically determine allocation for new runs of same or similar models.

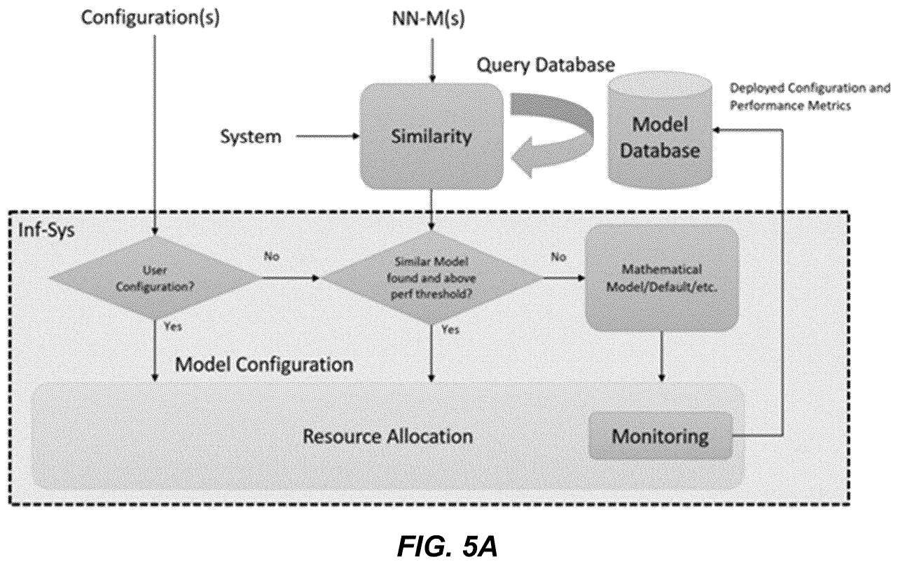

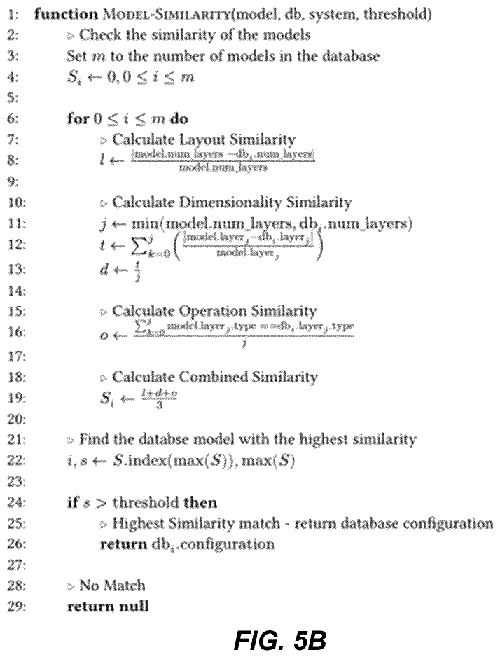

As an example, FIG. 5A shows the use of a database (“Model Database”) and performance monitoring to store a history of deployed NN-M configurations as well as their performance along with the measurement conditions. Illustratively, the database can store the TP, DP, and PP of the NN-M along with the throughput and latency as well as the AI-C load and number of outstanding I-Reqs at the time of measurement. As illustrated in FIG. 5A, this database is then exposed or feeds to a similarity analysis function (“Similarity”) which compares new models to those currently in the database.

As an example, the similarity analysis function can be implemented based on the high-level code as shown in FIG. 5B. This example implementation can generate a score (e.g., between 0 and 100) on the similarity between two NN-Ms. Various model metrics such as number of layers, dimensionality of the tensors, and layer operation types are taken into account when generating the score. A threshold on the score can be applied, for filtering/selecting matching models.

The user can specify the level of similarity to find matching model(s) in the database. The user can specify a performance threshold for additional control of model(s) returned from the match. In some implementations, among all matching models the one with the highest performance and match quality is selected. If no match is found then either a default configuration or method (e.g., those described in other techniques) can be used to determine model configuration. Alternatively or in addition, the user can choose to provide a configuration which can bypass the similarity analysis.

Below is an example use case scenario where such history-based method is desirable. After an initial deployment of a NN-M, an engineering team may continue to refine their NN-M creating new version with slight variations or taking new topologies from new public release. Often these new NN-Ms are similar enough to previously-run (older) NN-Ms, hence can be allocated in the same/similar manner as the previously seen NN-Ms.

Technique 4—automatically allocating AI inference system resources to AI model(s), based on profiling runs to search for target allocation.

Configurations selected by a user or computation-based methods, in various embodiments, ultimately need to act in accordance with certain assumptions about the system. Regardless of how well the system is modeled there likely is always a risk that the recommended configuration is non-optimal. There have been systems that used a simulation and binary search to attempt to address this issue, however they are limited and constrained by the accuracy of the simulation model.

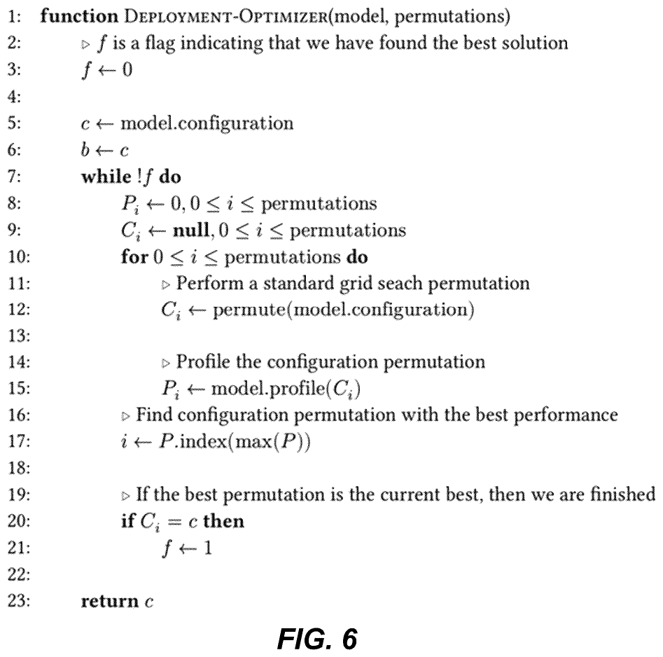

FIG. 6 illustrates an example high-level code for implementing embodiments of Technique 4, using configuration search based on iterative grid search. This configuration (of allocation) search method can be run as a pre-deployment step to sample the NN-M on the Inf-Sys aiming to find an optimal or target configuration. The method performs an iterative grid search increasing the permutation precision at each step. After each grid search the best configuration is found and compared to the previous best. If the current and previous best is the same or their difference is smaller than a threshold, then the final solution is determined to be found.

Technique 5—automatically allocating AI inference system resources to AI model(s), based on combination(s) of other techniques.

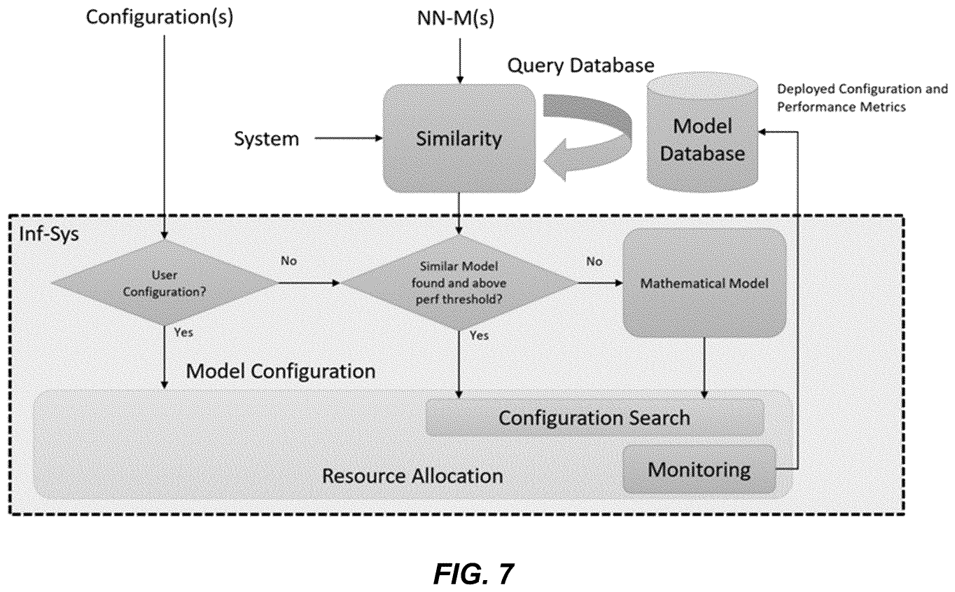

This technique includes using one or more combinations of the techniques presented above. Each of the methods and systems has trade-offs. For example, the mathematical model approaches can be fast and can work for any model, however it may be less accurate; the history and similarity approach relies on the existence of pertinent historical data and the accuracy of the similarity function; and the configuration search approach can be accurate but may ask to utilize system resources without their actual availability. A combined approach as illustrated in FIG. 7, aims to use the strengths of each technique while covering the trade-off of the others.

For example, given a new model to be deployed, if no similar models are found using Technique 3 (“Similarity”), then Techniques 1 or 2 (“Mathematical Model”) can be used to generate a configuration. If system resources are available then Technique 4 (“Configuration Search”) can be used to perform a search based on the generated configuration (e.g., using it as a starting point, as opposed to starting from a random configuration, for the configuration search to more quickly identify an optimal or target resource allocation solution). On the other hand, if using Technique 3 (“Similarity”) is able to find a match (e.g., the same or similar model was run previously), then the steps of Techniques 1 or 2 (“Mathematical Model”) and Technique 4 (“Configuration Search”) can be skipped entirely and the new model can be deployed directly based on resource allocation configuration of the previously-run, matching model. In some cases, Technique 4 is still applied after a matching model is identified via Technique 3 (“Similarity”). In these cases, the resource allocation configuration of the previously-run, matching model can be used as the starting point for the configuration search to quickly identify an optimal or target resource allocation solution for the new model. The newly identified optimal or target resource allocation solution as well as its performance can be monitored and associated with the new model, and that association along with all relevant data can be organized and stored in the database (“Model Database”) to keep it up to date for handling future model(s) to be deployed.

In accordance with various embodiments, the presently disclosed technology implements intelligent request scheduling using one or more of the following techniques:

Technique 6—dynamically scheduling AI inference requests to system resources, based on matching the predicted amount of resources the requests may use to the current available resources in the system.

A desired scheduler can determine or obtain data regarding (a) the amount of resources needed to process incoming requests (Reqs), (b) the amount of resources currently available in the AI inference system, and (c) efficient matching of the requests to system resources such that it aims to achieve maximized system utilization and performance. However, as described above, request scheduling in existing Inf-Sys is typically performed using a First Come, First Served Round Robin (FCFS-RR) approach, which does not account for resource requirements of the input requests such as memory or computation, nor the available resources in the system. It simply works based on time of arrival of requests (i.e., first incoming request gets processed first) and taking turns on assigning to the system resources (i.e., if AI-C1 got assigned last time, next turn is AI-C2).

For certain neural networks, such as transformer-based models discussed above, the resource usage cannot be statically determined due to the dynamic nature of their outputs. As such FCFS-RR may mistakenly assign an incoming request that needs a lot of resources to an AI-C that has low resource availability, which then would result in low performance in serving the request.

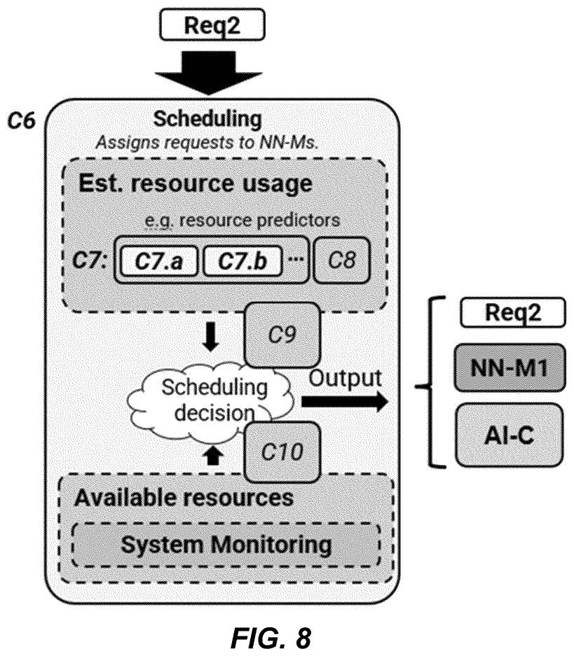

FIG. 8 shows an example implementation of dynamic resource-aware scheduling in accordance with Technique 6, where an intelligent scheduling system incorporates (a) a prediction mechanism to estimate the amount of resources needed by incoming requests, and (b) system monitoring to track available system resources dynamically, with (c) a mechanism to make scheduling decision based on matching estimated resource requirements of incoming requests to available system resources at a given time.

This type of scheduler can make more optimal scheduling decisions, resulting in improved system resource utilization and requests processing performance. For example, the scheduler can ensure that the resources available in an AI compute device (AI-C), such as arithmetic units and memories, are adequate before scheduling an input request to that AI-C. If the available resources are insufficient, the scheduler can iteratively identify alternative AI-Cs until a suitable match is found.

While the scheduling system can utilize various applicable methods to estimate resources of incoming requests (i.e., depicted in FIG. 8 as “Est. resource usage” sub-system), without loss of generality, example resource usage prediction methods of Techniques 7 and 8 will be described below. While the scheduling system can utilize various applicable scheduling decision methods (i.e., depicted in FIG. 8 as “Scheduling decision” sub-system) to assign incoming requests (Reqs) to system (Inf-Sys) resources, without loss of generality, example methods of Techniques 9 and 10 for making scheduling decisions are described below will be described below.

Technique 7—predicting resource usage using historical data and adaptive multi-predictors.

This technique includes predicting resource usage in AI-based services by leveraging multiple prediction methodologies and/or diverse historical data. Existing approaches typically do not keep track of historical information (e.g., from prior runs on the AI inference system) to make future predictions. Also, only relying on a single prediction method can be inflexible and inefficient under varying workloads or resource constraints. Given that certain system behaviors and input/output patterns can repeat, historical system behavior can help predict future system behavior.

Technique 7 involves using one or more pieces of historical information of prior system runs (e.g., request types, user pattern in generating requests, etc.) and one or more prediction methods that incorporate the insights from historical information in making its prediction. More specifically, the system can integrate a combination of prediction methods, each tailored to different scenarios, and incorporate various types of historical data to enhance accuracy and adaptability. The dynamic selection strategy enables the system to determine efficient resource allocation by choosing the most suitable prediction method or a combination of methods based on current load, user behavior, request complexity, combination of the same or the like, ensuring robust performance across diverse conditions.

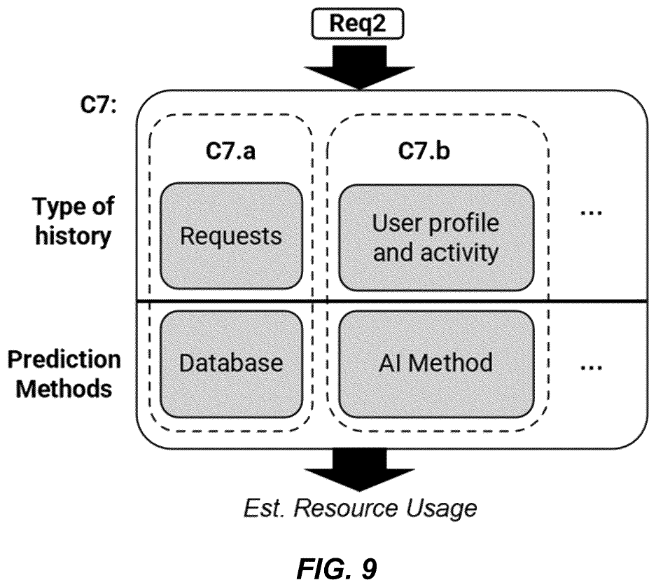

FIG. 9 shows an example implementation of dynamic resource usage predictor in accordance with some embodiments of Technique 7. As depicted by FIG. 9, this implementation includes multiple, distinct prediction methods, each configured to estimate resource usage based on different methodologies and combinations of historical information. The prediction methods are not limited to a specific type and may include, but are not limited to:
i. Lightweight, database-backed similarity methods;
ii. AI-based inference methods;
iii. Statistical modeling methods;
iv. Rule-based heuristic methods; and
v. Any combination thereof.

Each prediction method can utilize a combination of different types of historical information, including but not limited to:
i. User-specific data, such as prior requests, response lengths, and resource usage;
ii. Temporal data, such as diurnal activity patterns; and
iii. Contextual data, such as the content or complexity of incoming requests.

The implementation depicted by FIG. 9 includes a dynamic selection strategy for determining the appropriate prediction method or combination of methods, based on system workload, user characteristics, and request complexity, for example:
in high-load scenarios, low-resource methods are prioritized to maintain efficiency; and
in low-load scenarios, high-resource methods are used for greater accuracy.

The implementation also includes a scheduling system that integrates resource usage predictions generated by the selected method(s) with an aim to optimize resource allocation for diverse workloads.

As a use case example, for a ChatBot AI inference system, a piece of historical information being tracked can be the length of prior input Requests (i.e., the length of user prompts) from User A, the length of responses produced, as well as system resources used to generate the responses. If User A often issues input prompts that result in a few words of response using X amount of AI-C compute and Y amount of AI-C memory, this would enable predictions that a future input prompt from User A can likely produce a few words of response and needing X and Y compute and memory from AI-C resources.

Sub-Technique 7.a—predicting resource usage using a database-backed similarity approach.

This sub-technique includes a non-AI approach for predicting resource usage by leveraging historical user data stored in a database. An example method of this sub-technique focuses on efficiency and simplicity, making it particularly suited for high-load scenarios where rapid predictions are desired. By utilizing a similarity-search algorithm, this method can match incoming requests with prior user interactions to estimate resource needs. Illustratively, the method operates as follows: historical user data, including prior requests and resource usage, is stored in a database, and a similarity-search method of algorithm is used to analyze incoming requests by comparing them with historical data to predict resource usage.

For example, in a language model-based inference system, the system can employ Vector Database-based similarity analysis to predict output token length. By comparing a given prompt with a user's N most recent prompts stored in the database and using the associated token lengths, the system can efficiently estimate resource usage.

Sub-Technique 7.b—predicting resource usage using AI-based models incorporating user history.

This sub-technique includes an AI-based approach to predicting resource usage, aiming to deliver higher accuracy by incorporating user-specific historical data into the prediction process. An example method uses machine learning models, such as fine-tuned language models, to analyze patterns in user behavior and adapt predictions accordingly. By integrating features such as past prompts, resource usage, and contextual information, this approach can enhance the model's ability to tailor predictions to individual users. It can be particularly effective in low-load scenarios or for users with complex or highly variable requests, where precision in resource estimation is prioritized. Illustratively, the method can operates as follows: user-specific historical data, such as prior prompts and resource usage, is incorporated as input features for an AI model; the AI model is fine-tuned on datasets that include sequences of user interactions, enabling it to learn and adapt to patterns in user behavior over time; and the AI-based approach provides high prediction accuracy by leveraging user-specific patterns and historical interactions.

For example, given that the system uses both the current prompt and the user's last N historical output token lengths as input features, if a user frequently submits follow-up prompts to refine previous outputs, the AI model learns this behavior by analyzing patterns in the historical data. As a result, the AI model can predict that similar prompts will likely generate outputs of comparable length. This approach enables the system to make accurate and personalized resource predictions tailored to the specific habits and patterns of individual users.

Technique 8—predicting resource usage using multiple complexity predictors that are dynamically chosen based on available system load of resources.

There are multiple methods to predict resource usage of incoming requests (e.g., as described in Technique 7 and others). There are tradeoffs among the different predictors, where some can be less complex and require less resources to run, yet they may be less accurate or have limited prediction scope (e.g., tailored only for certain use case or scenarios of requests).

Technique 8 includes a scheduling approach that uses multiple predictors of varying complexity and chooses the most suitable one to invoke based on dynamic system load (e.g., resources available as well as system demands from incoming requests). As an example, if system load is low (e.g., not many requests are being processed, many AI-Cs are available, etc.), it has an abundance of resources to run a more complex predictor that can achieve higher accuracy. In contrast, if system load is high (e.g., many incoming requests to process, lack of AI-C available resources, etc.), then a less complex predictor that uses a lower amount of resources can be used. While it may offer less accuracy, it allows for fast prediction while using a low amount of system resources.

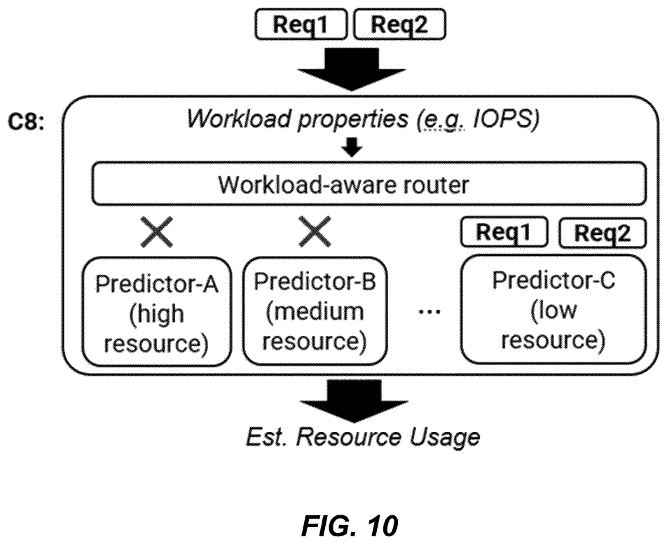

FIG. 10 shows an example implementation of load-aware tiered resource usage prediction in accordance with some embodiments of Technique 8. Illustratively, the prediction system accepts requests, reroute them to lightweight predictor(s) when the workload demands high resources, and vice-versa. In this example, when there is heavy load in the system, Predictor-C that uses low system resources is selected. As shown in FIG. 10, the multiple predictors are selected in a manner to dynamically adapt to system load, providing suitable or targeted trade-offs between prediction accuracy and computational overhead.

As a use case example, a cloud-based AI service needs to handle requests of varying computational intensity:

High-Load Scenario—during peak usage hours, the service experiences an influx of requests, causing resource contention. To prevent bottlenecks, the scheduling system can use a lightweight database-driven model to quickly predict approximate resource usage based on precomputed averages or patterns, allowing rapid request allocation with minimal delay.

Low-Load Scenario—during off-peak hours, with abundant resources available, the system can switch to a fine-tuned language model or other heavyweight model(s) for more precise predictions. This model can analyze richer input features, such as the specific query content or historical usage patterns, to make more accurate scheduling decisions.

This flexibility is particularly advantageous for deployments in resource-constrained environments, such as servers with limited GPU availability, as it can ensure efficient operation across varying system loads. While it may be possible to simply use low-resource, simple predictor all the time, which does not require a lot of resources to run, Technique 8 enables dynamic and efficient usage of a better performing (but more complex) predictor when resources are available to run such a complex predictor.

Technique 9—dynamically scheduling AI Inference requests to system resources, based on the estimated amount of resource to be used.

The resource requirements of incoming requests to a model deployment can vary significantly. For example, in LLM inference, some requests may have long user-provided inputs that result in shorter generated output lengths, whereas some requests may have short user-provided inputs that result in longer generated output lengths. Because computing on the LLM input has different resource utilization characteristics than computing the LLM output, the resource requirements of incoming requests can be an important factor for scheduling determination. Typical heuristic-based schedulers (e.g., FCFS-RR) which do not factor in request resource prediction may incidentally assign many requests, all with high memory requirements and low compute requirements, to a system resource (e.g., AI-C1) that has low memory availability. As the requests are not getting sufficient resource in this case, it would result in low performance or even cancellation of the request and reassignment to another system resource.

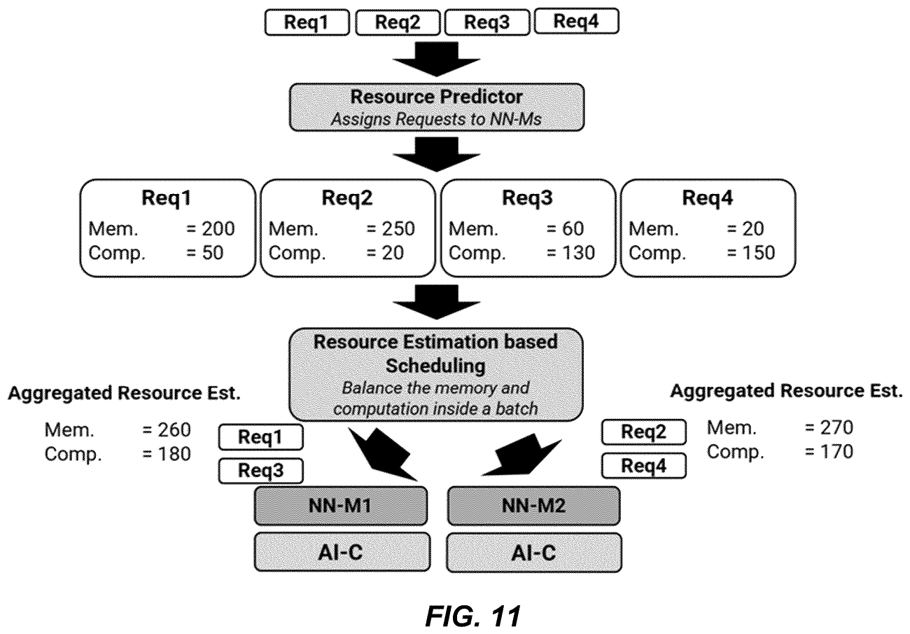

Technique 9 includes incorporating resource prediction (e.g., by using resource prediction strategies from Technique 7 and 8, or any other applicable prediction methods) into the request scheduling decision. FIG. 11 illustrates an example implementation of resource predictor-based request scheduling in accordance with some embodiments of Technique 9.

In this implementation, the resource prediction-based scheduler predicts both the compute and memory resource requirements of individual requests. With multiple requests, the scheduler groups together requests with differing resource requirements before sending them for model deployments. High-memory-low-compute requests are grouped with low-memory-high-compute requests, resulting in more balanced utilization of AI hardware and thus higher performance.

As shown in FIG. 11, the resource predictor estimates the memory and computation requirements for incoming requests (Req1 to Req4). Based on these predictions:

Req1 and Req2 are estimated to have higher memory requirements compared to their computational demands.

Req3 and Req4 are estimated to exhibit the opposite trend, with higher computational requirements and relatively lower memory needs.

To achieve desired resource utilization of model deployments, the scheduler groups Req1 with Req3, and Req2 with Req4, before distributing them NN-M1 and NN-M2. This grouping balances the overall memory and compute resource demands across the system, ensuring that neither resource is overutilized or underutilized.

Technique 10—dynamically scheduling AI Inference requests to system resources, based on the dynamically monitored available resources in the system.

Scheduling requests to model deployments (NN-Ms) is typically done via simple heuristic-based methods, such as First-Come-First-Served Round-Robin (FCFS-RR) scheduling. However, these heuristic based methods can lead to imbalanced resource utilization and thus suboptimal performance across the serving cluster due to the high resource requirements of some AI inference jobs. Resource-unaware schedulers may send requests to model deployments with low resource availability (e.g., sending a request to a model replica that lacks sufficient memory bandwidth), which will further stress that deployment and result in poor performance.

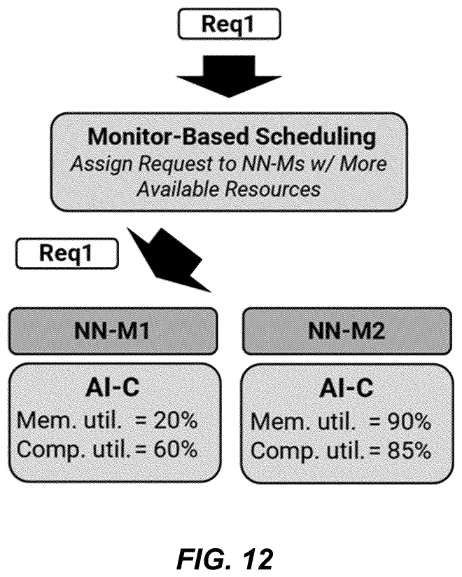

Technique 10 includes incorporating resource monitoring into the request scheduling decision. FIG. 12 shows an example implementation of resource monitoring-based scheduling in accordance with embodiments of Technique 10. In this implementation, incoming requests are routed to model deployments with high resource availability to achieve high performance. The fine-grained usage of resources is monitored, such as compute units, memory bandwidth/capacity, etc., which then informs the routing decisions.

As shown in FIG. 12, when Req1 arrives, the system monitor evaluates the current resource utilization across available NN-Ms. NN-M1 is observed or determined to have a lower utilization for both memory and computation as compared with NN-M2. To balance resource utilization across the system and prevent overloading any single NN-M, the scheduler assigns and routes Req1 to NN-M1. This approach can ensure that requests are distributed efficiently, aiming to maximize the use of available resources

In some embodiments, resource monitoring-based scheduling can be used in tandem with resource prediction-based scheduling (e.g., Technique 9). In some embodiments, resource monitoring-based scheduling is used independently, e.g., as shown in FIG. 9.

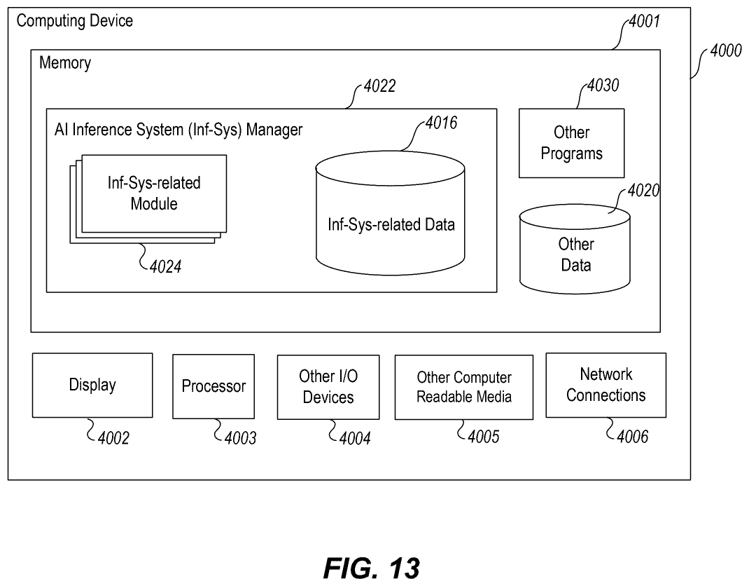

FIG. 13 is a block diagram illustrating a computing system or device 4000 used to implement some or all the functionalities of the technology disclosed herein. The computing system or device 4000 may include the AI inference system, may be a part of the AI inference system, or may be separate from the AI inference system, depending on embodiments of functionalities as performed. According to some embodiments, one or more general purpose or special purpose computing systems or devices may be used to implement the computing system or device 4000. In addition, according to some embodiments, the computing system or device 4000 may comprise one or more distinct computing systems or devices and may span distributed locations. Furthermore, each block shown in FIG. 13 may represent one or more such blocks as appropriate to a specific embodiment or may be combined with other blocks. Also, the AI inference system (Inf-Sys) manager 4022 may be implemented in software, hardware, firmware, or in some combination to achieve the capabilities described herein.

As shown, the computing system or device 4000 includes a non-transitory computer memory (“memory”) 4001, a display 4002 (including, but not limited to a light emitting diode (LED) panel, cathode ray tube (CRT) display, liquid crystal display (LCD), touch screen display, projector, etc.), one or more processors 4003 (including, but not limited to one or more of CPUs, GPUs, TPUs, NNPs, FPGAs, or ASICs), Input/Output (“I/O”) devices 4004 (e.g., keyboard, mouse, RF or infrared receiver, universal serial bus (USB) ports, High-Definition Multimedia Interface (HDMI) ports, other communication ports, and the like), other computer-readable media 4005, and network connections 4006. The Inf-Sys manager 4022 is shown residing in memory 4001. In other embodiments, some portion of the contents and some, or all, of the components of the Inf-Sys manager 4022 may be stored on or transmitted over the other computer-readable media 4005. The components of the computing system or device 4000 and Inf-Sys manager 4022 can execute on one or more processors 4003 and implement applicable functions described herein. In some embodiments, the Inf-Sys manager 4022 may operate as, be part of, or work in conjunction or cooperation with other software applications stored in memory 4001 or on various other computing devices. In some embodiments, the Inf-Sys manager 4022 also facilitates communication with peripheral devices via the I/O devices 4004, or with another device or system via the network connections 4006.

The one or more Inf-Sys-related modules 4024 are configured to perform actions related, directly or indirectly, to resource allocation, request scheduling, or other functionalities disclosed herein. In some embodiments, the Inf-Sys-related module(s) 4024 stores, retrieves, or otherwise accesses at least some Inf-Sys-related data on some portion of the Inf-Sys-related data storage 4016 or other data storage internal or external to the computing system or device 4000.

Other code or programs 4030 (e.g., further data processing modules, a program guide manager module, a Web server, and the like), and potentially other data repositories, such as data repository 4020 for storing other data, may also reside in the memory 4001, and can execute on one or more processors 4003. Of note, one or more of the components in FIG. 13 may or may not be present in any specific embodiment. For example, some embodiments may not provide other computer-readable media 4005 or a display 4002.

According to some embodiments, the computing system or device 4000 and Inf-Sys manager 4022 include API(s) that provides programmatic access to add, remove, or change one or more functions of the computing system or device 4000. In some embodiments, components/modules of the computing system or device 4000 and Inf-Sys manager 4022 are implemented using standard programming techniques. For example, the Inf-Sys manager 4022 may be implemented as an executable running on the processor(s) 4003, along with one or more static or dynamic libraries. In other embodiments, the computing system or device 4000 and Inf-Sys manager 4022 may be implemented as instructions processed by a virtual machine that executes as one of the other programs 4030. In general, a range of programming languages known in the art may be employed for implementing such example embodiments, including representative embodiments of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware embodiment, instructions stored in a memory configure, when executed, one or more processors of the computing system or device 4000 to perform the functions of the Inf-Sys manager 4022. In some embodiments, instructions cause the processor(s) 4003 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a Inf-Sys manager 4022 embodiment. Also, other functions could be implemented or performed by each component/module, and in different orders, and by different components/modules, yet still achieve the functions of the computing system or device 4000 and Inf-Sys manager 4022.

In addition, programming interfaces to the data stored as part of the computing system or device 4000 and Inf-Sys manager 4022, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The model-related data storage 4016 and data repository 4020 may be implemented as one or more database systems, file systems, or any other technique for storing such information, or any combination of the above, including embodiments using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the Inf-Sys manager 4022.

Furthermore, according to some embodiments, some or all of the components of the computing system or device 4000 and Inf-Sys manager 4022 may be implemented or provided in other manners, such as at least partially in firmware or hardware, including, but not limited to one or more application-specific integrated circuits (“ASICs”), standard integrated circuits, controllers (e.g., by executing appropriate instructions, and including microcontrollers or embedded controllers), field-programmable gate arrays (“FPGAs”), complex programmable logic devices (“CPLDs”), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A computer-implemented method comprising:
obtaining a target artificial intelligence (AI) model to be deployed via an AI inference system;
comparing the target AI model to a plurality of reference AI models previously deployed via the AI inference system;
responsive to a result of the comparing:
obtaining a base allocation configuration of resources including at least memory and compute resources, for deploying the target AI model via the AI inference system; and
performing a configuration search based on the base allocation configuration to obtain a finalized allocation configuration; and
allocating resources of the AI inference system to implement the target AI model based on the finalized allocation configuration.

2. The method of claim 1, wherein comparing the target AI model to the plurality of reference AI models comprises one or more of:
calculating one or more layout similarities between the target AI model and the plurality of reference AI models;
calculating one or more dimensional similarities between the target AI model and the plurality of reference AI models; or
calculating one or more operation similarities between the target AI model and the plurality of reference AI models.

3. The method of claim 2, wherein comparing the target AI model to the plurality of reference AI models includes:
calculating one or more combined similarities based on the one or more layout similarities, the one or more dimensional similarities, and the one or more operation similarities.

4. The method of claim 1, wherein comparing the target AI model to the plurality of reference AI models is based on a similarity threshold.

5. The method of claim 4, wherein the result of the comparing indicates successful identification of a base AI model from the plurality of reference AI models that is within the similarity threshold to the target AI model, and wherein the base allocation configuration is associated with the base AI model.

6. The method of claim 1, wherein the result of the comparing indicates that no reference AI model is found to match the target AI model, and wherein obtaining the base allocation configuration comprises determining one or more of a pipeline parallelism, tensor parallelism, or data parallelism for the target AI model.

7. The method of claim 6, comprising:
calculating a cache size to implement the target AI model based on a memory usage of a request;
calculating a minimum number of compute units to implement the target AI model based on a size of the target AI model, the cache size, and a memory capacity of a compute unit;
determining the pipeline parallelism for the target AI model based on the minimum number of compute units and a number of compute units per node;
determining the tensor parallelism for the target AI model based on the minimum number of compute units and the pipeline parallelism;
determining the data parallelism for the target AI model based on a number of compute units, the tensor parallelism, and the pipeline parallelism; and
determining the base allocation configuration based on one or more of the tensor parallelism, the pipeline parallelism, or the data parallelism.

8. The method of claim 7, comprising:
obtaining a latency target for the target AI model;
calculating an execution time per compute unit for the target AI model; and
modifying the tensor parallelism based on the execution time per compute unit.

9. The method of claim 1, comprising:
tracking a performance metric of one or more of the plurality of reference AI models implemented via the AI inference system; and
determining the base allocation configuration based on the performance metric.

10. The method of claim 1, wherein performing the configuration search comprises:
iteratively altering the base allocation configuration;
for each iteration of the altering, determining performance of a respective base allocation configuration of the iteration by implementing the target AI model according to the altering of the base allocation configuration of the iteration;
determining that a difference between the performance of a respective base allocation configuration of a first iteration and the performance of a respective base allocation configuration a second iteration is smaller than a performance similarity threshold; and
determining the finalized allocation configuration based on determining that the difference is smaller than the performance similarity threshold.

11. A system comprising:
one or more processors; and
one or more non-transitory computer-readable media collectively storing instructions that, when collectively executed by the one or more processors, cause the system to perform actions, the actions comprising:
comparing a target AI model to a plurality of reference AI models previously implemented via an AI inference system;
responsive to a result of the comparing:
obtaining a base allocation configuration of resources for implementing the target AI model via the AI inference system; and
performing a configuration search based on the base allocation configuration to obtain a finalized allocation configuration; and
causing allocation of resources of the AI inference system to implement the target AI model based on the finalized allocation configuration.

12. The system of claim 11, wherein comparing the target AI model to the plurality of reference AI models comprises one or more of:
calculating one or more layout similarities between the target AI model and the plurality of reference AI models;
calculating one or more dimensional similarities between the target AI model and the plurality of reference AI models; or
calculating one or more operation similarities between the target AI model and the plurality of reference AI models.

13. The system of claim 11, wherein comparing the target AI model to the plurality of reference AI models is based on a similarity threshold.

14. The system of claim 13, wherein the result of the comparing indicates successful identification of a base AI model from the plurality of reference AI models that is within the similarity threshold to the target AI model, and wherein the base allocation configuration is associated with the base AI model.

15. The system of claim 11, wherein the result of the comparing indicates that no reference AI model is found to match the target AI model, and wherein obtaining the base allocation configuration comprises determining one or more of a pipeline parallelism, tensor parallelism, or data parallelism for the target AI model.

16. The system of claim 11, wherein the system includes the AI inference system.

17. A non-transitory processor-readable storage medium storing computer instructions that, when executed by one or more processors, cause actions to be performed, the actions comprising:
comparing a target AI model to a plurality of reference AI models previously implemented via an AI inference system;
responsive to a result of the comparing:
obtaining a base allocation configuration of resources for implementing the target AI model via the AI inference system; and
performing a configuration search based on the base allocation configuration to obtain a finalized allocation configuration; and
causing allocation of resources of the AI inference system to implement the target AI model based on the finalized allocation configuration.

18. The non-transitory processor-readable storage medium of claim 17, wherein the actions comprise:
obtaining a latency target for the target AI model;
calculating an execution time per compute unit for the target AI model; and
modifying a tensor parallelism for the target AI model based on the execution time per compute unit.

19. The non-transitory processor-readable storage medium of claim 17, wherein the actions comprise:
tracking a performance metric of one or more of the plurality of reference AI models implemented via the AI inference system; and
determining the base allocation configuration based on the performance metric.

20. The non-transitory processor-readable storage medium of claim 17, wherein performing the configuration search comprises:
iteratively altering the base allocation configuration;
for each iteration of the altering, determining performance of a respective base allocation configuration of the iteration by implementing the target AI model according to the altering of the base allocation configuration of the iteration;
determining that a difference between the performance of a respective base allocation configuration of a first iteration and the performance of a respective base allocation configuration a second iteration is smaller than a performance similarity threshold; and
determining the finalized allocation configuration based on determining that the difference is smaller than the performance similarity threshold.
